(19) United States
(12) Patent Application Publication
(10) Pub. No.: US 2015/0362652 A1
(43) Pub. Date: Dec. 17, 2015

(54) LIGHTING DEVICE, DISPLAY DEVICE, AND TELEVISION RECEIVING DEVICE

(71) Applicant: SHARP KABUSHIKI KAISHA, Osaka (JP)

(72) Inventors: Keiji HAYASHI, Osaka (JP); Eiji NITTOU, Osaka (JP); Toshikazu MATSUKAWA, Osaka (JP); Nobuyuki NAKAMURA, Osaka (JP); Yoshitsugu KAWAHIGASHI, Osaka (JP); Takeshi SUZUKI, Yonago-shi, Tottori (JP)

(73) Assignee: Sharp Kabushiki Kaisha, Osaka (JP)

(21) Appl. No.: 14/763,805

(22) PCT Filed: Jan. 21, 2014
(86) PCT No.: PCT/JP2014/051047

§ 371 Date: Jul. 27, 2015

(30) Foreign Application Priority Data
Jan. 28, 2013 (JP) 2013-013068

(51) Int. Cl. F21V 8/00

(52) U.S. Cl. CPC G02B 6/005; G02B 6/0051; G02B 6/0088; G02B 6/0073

(57) ABSTRACT

A backlight device includes an LED; a light guide plate that has a light-exiting surface provided at one plate surface, an opposite surface provided at a plate surface on the opposite side to the light-exiting surface, and a light-receiving side face provided at one side face, that is arranged such that the light-receiving side face faces the LED and that guides light from the LED; a chassis having a plate surface arranged so as to face the opposite surface and housing at least the LED and the light guide plate; and an optical sheet that is arranged so as to face the light-exiting surface, that provides light that has exited the light guide plate with an optical function and that has a bent portion that extends further toward the outside than an edge of the light-exiting surface and is bent toward the opposite surface side and as a result covers at least part of a side face of the light guide plate.

### TECHNICAL FIELD

The present invention relates to an illumination device, a display device and a television receiver.

### BACKGROUND ART

In recent years, the display elements of image display devices such as television receivers have made it possible to reduce the thickness of image display devices with the advancement from conventional cathode-ray tubes to thin display devices in which thin display elements are used, such as liquid crystal panels and plasma display panels. Since a liquid crystal panel used in a liquid crystal display device does not emit light itself, a backlight device is needed as a separate illumination device. As an example of such a backlight device, an edge-lit-type backlight device is known in which a light-receiving side face is provided at a side face of a light guide plate, and light sources such as LEDs are arranged so as to face the light-receiving side face.

In such an edge-lit-type backlight device, optical sheets for providing light that has exited the light guide plate with optical functions may be provided on a light-exiting-surface side of the light guide plate. In such a configuration in which optical sheets are arranged, there is a concern that a phenomenon will occur in which part of the light that has exited the light guide plate will be reflected at a side face of an optical sheet and a bright line will appear on the display surface of the backlight device.

In Patent Document 1, a backlight device is disclosed that aims to prevent or suppress the phenomenon in which a bright line is generated on the display surface due to light being reflected at a side face of an optical sheet. In this backlight device, side faces of the optical sheets are caused to be spaced apart from the display surface by making the optical sheets extend further toward the outside than the edge of the light-exiting surface of the light guide plate. Consequently, the phenomenon in which light reflected at a side face of an optical sheet heads toward the display surface side is prevented or suppressed.

### RELATED ART DOCUMENT

### Patent Document

Patent Document 1: Japanese Patent Application Laid-Open Publication No. 2002-169152

### Problems to be Solved by the Invention

However, when the optical sheets are made to extend further toward the outside than an edge of the light-exiting surface of the light guide plate as in the backlight device of Patent Document 1, a space is needed inside the casing to house the extending portion. Consequently, it is difficult to make the border of the backlight device slim.

### SUMMARY OF THE INVENTION

The technology disclosed in the present specification was created in light of the above-described problem. An object of technology disclosed in the present specification is to make it possible to achieve a slim border while preventing or suppressing generation of bright lines on a display surface caused by light reflected at a side face of an optical sheet.

### Means for Solving the Problems

A technology disclosed in the present specification relates to an illumination device that including: a light source; a light guide plate guiding light from the light source and having a light-exiting surface provided at one plate surface, an opposite surface provided at a plate surface on a side opposite to the light-exiting surface, and a light-receiving side face provided at at least one of side faces of the light guide plate, the light guide plate being arranged such that the light-receiving side face faces the light source; a housing member having at least a plate surface facing the opposite surface of the light guide plate and housing at least the light source and the light guide plate; and an optical sheet facing the light-exiting surface of the light guide plate and exerting an optical effect on light that has exited therefrom, the optical sheet having a bent portion that extends further outward than an end of the light-exiting surface and that bends toward the opposite surface of the light guide plate, thereby at least partially covering one of the side faces of the light guide plate.

In the illumination device, the bent portion of the optical sheet is bent toward the opposite surface side, and therefore even if light that has exited the light-exiting surface of the light guide plate is reflected at a side face of the bent portion, the reflected light does not head toward the light emission side (light-exiting surface side) of the illumination device but rather heads toward the side of the illumination device. Consequently, in the case where a display panel is arranged at the light emission side of the illumination device, the generation of bright lines caused by the reflected light at an edge of the display panel can be prevented or suppressed. In addition, in the illumination device, the bent portion is bent toward the opposite surface side of the light guide plate and therefore there is no need to provide extra space in which to arrange the bent portion outside the light guide plate. Consequently, the border of the illumination device can be made slim. As described above, in the illumination device, a slim border can be achieved while preventing or suppressing generation of bright lines on a display surface caused by light reflected at a side face of an optical sheet.

The bent portion may be arranged over at least a light-receiving side face side among the side faces of the light guide plate.

With this configuration, at least part of light heading toward the light-receiving side face after exiting the light source will be transmitted through the bent portion. At this time, light that is transmitted through the bent portion enters the optical sheet from the opposite side to the side from which light that has exited the light-exiting surface enters. Here, the optical sheet having the bent portion performs a function of causing light that has exited the light-exiting surface of the light guide plate to converge. Consequently, light that has been transmitted through the bent portion out of light heading toward the light-receiving side face after exiting the light source is diffused, and as a result, uneven brightness on the light-receiving side face side of the light guide plate can be prevented or suppressed.

The bent portion arranged over the light-receiving side face side may extend toward the plate surface beyond a location that faces a light-emitting surface of the light source.

With this configuration, the majority of light heading toward the light-receiving side face after exiting the light source is transmitted through the bent portion, and therefore the light heading toward the light-receiving side face after exiting the light source can be effectively diffused. Thus, uneven brightness on the light-receiving side face side of the light guide plate can be prevented or suppressed to a greater degree.

The light source may be a point light source.

Compared with a linear light source for example, uneven brightness tends to be more likely to occur with a point light source due to the high brightness in a portion close to the light source. With the above configuration, since light from the point light source is transmitted through the bent portion and diffused, uneven brightness can be suppressed as compared with a configuration of the related art that does not have a bent portion.

The optical sheet may include two diffusion sheets and a lens sheet interposed therebetween.

With this configuration, a specific configuration can be provided for the optical sheet with which light is diffused by being transmitted through the bent portion.

The point light source may be an LED package including a plurality of LED chips that respectively emit light of differing colors.

With this configuration, a specific configuration can be provided for the point light source with which light is effectively diffused by being transmitted through the bent portion.

The optical sheet may include two diffusion sheets.

With this configuration, a specific configuration can be provided for the optical sheet with which light is effectively diffused by being transmitted through the bent portion for the case of an LED package including a plurality of LED chips that emit light of different colors.

The bent portion of the optical sheet may have an opposite surface covering portion that extends to the opposite surface of the light guide plate and that covers a part of the opposite surface.

With this configuration, a part of the bent portion that extends to the opposite surface side can be interposed between the light guide plate and another member, and a state in which the bent portion including the opposite surface covering portion is bent can be effectively maintained.

The opposite surface covering portion may extend from a part of the bent portion.

With this configuration, the size of the portion (opposite surface covering portion) of the bent portion that is fixed in place by being interposed between the light guide plate and another member can be reduced, and therefore the occurrence of wrinkles generated in the vicinity of the portion at the time of for example thermal expansion and contraction of the optical sheet due to the portion being fixed in place can be suppressed.

The opposite surface covering portion may be fixed to the opposite surface of the light guide plate by adhesive tape.

With this configuration, by fixing the opposite surface covering portion to the light guide plate with the adhesive tape, the state in which the bent portion including the opposite surface covering portion is bent can be more effectively maintained.

The bent portion may cover an entirety of at least one of the side faces of the light guide plate.

With this configuration, a greater amount of light out of the light heading toward a side face of the optical sheet after exiting the light-exiting surface of the light guide plate can be made to head toward a side face of the bent portion. Thus, reflection of light at a side face of the optical sheet can be more effectively prevented or suppressed.

The light guide plate and the optical sheet may each have a rectangular shape when viewed in a plan view, and the bent portion may be respectively provided at one long-side and one short-side of the optical sheet.

In order to make a greater amount of light out of the light heading toward a side face of the optical sheet head toward a side face of the bent portion, it is preferable that the bent portion be provided at each edge of the optical sheet. However, if a bent portion were provided at each edge of the optical sheet, it would be likely that wrinkles would occur in the vicinity of the bent portions at the time of thermal expansion and contraction of the optical sheet for example. Consequently, it is preferable that the bent portion not be provided on the edges on the opposite sides to the edges at which the bent portions are provided in the optical sheet in order to eliminate such wrinkles. With this configuration, a configuration can be provided that realizes both a configuration for causing a greater amount of light to head toward side faces of the bent portions and a configuration for eliminating wrinkles generated at for example the time of thermal expansion and contraction.

The technology disclosed in the present specification can also be implemented as a display device including a display panel that performs display using light from the illumination device. In addition, a display device in which the display panel is a liquid crystal panel using liquid crystal is novel and useful. Furthermore, a television receiver including the display device is novel and useful.

### Effects of the Invention

According to the technology disclosed in the present specification, it is possible to provide a slim border while preventing or suppressing reflection of light at a side face of an optical sheet.

### BRIEF DESCRIPTION OF THE DRAWINGS

FIG. 1 is an exploded perspective view of a television receiver TV according to Embodiment 1.

FIG. 2 is an exploded perspective view of a liquid crystal display device 10.

FIG. 3 is a cross-sectional view of a section obtained by cutting the liquid crystal display device 10 along the Y-Z plane.

FIG. 4 is a cross-sectional view of a section obtained by cutting the liquid crystal display device 10 along the X-Z plane.

FIG. 5 is an enlarged cross-sectional view in which a region in the vicinity of a bent portion 19 in FIG. 4 is enlarged.

FIG. 6 is an exploded perspective view of the liquid crystal display device 10 according to a modification example of Embodiment 1.

FIG. 7 is an exploded perspective view of a liquid crystal display device 110 according to Embodiment 2.

FIG. 8 is a cross-sectional view of a section obtained by cutting the liquid crystal display device 110 along the Y-Z plane.

FIG. 9 is an enlarged plan view in which a region in the vicinity of a light-receiving side face 120a of a backlight device 124 is enlarged.

FIG. 10 is an exploded perspective view of a liquid crystal display device 210 according to Embodiment 3.

FIG. 11 is a cross-sectional view of a section obtained by cutting the liquid crystal display device 210 along the Y-Z plane.

FIG. 12 is an enlarged front view of an LED 228.

FIG. 13 is an exploded perspective view of a liquid crystal display device 310 according to Embodiment 4.

FIG. 14 is a cross-sectional view of a section obtained by cutting the liquid crystal display device 310 along the X-Z plane.

FIG. 15 is an enlarged cross-sectional view in which a region in the vicinity of a bent portion 319 in FIG. 14 is enlarged.

FIG. 16 is an exploded perspective view of a liquid crystal display device 410 according to Embodiment 5.

### DETAILED DESCRIPTION OF EMBODIMENTS

### Embodiment 1

Embodiment 1 will be described while referring to the drawings. In this embodiment, a liquid crystal display device (example of display device) 10 will be exemplified. An X axis, a Y axis and a Z axis are illustrated in part of each drawing and the axes are drawn so that the directions of the axes are consistent in all the drawings. Among these directions, the Y axis direction coincides with the vertical direction and the X axis direction coincides with the horizontal direction. In addition, unless otherwise noted, description of up or down refers to the vertical direction.

A television receiver TV includes a liquid crystal display device 10, front and back cabinets Ca and Cb that house the liquid crystal display device 10 so as to be interposed therebetween, a power supply P, a tuner T and a stand S. The liquid crystal display device 10 has a horizontally elongated rectangular shape on the whole and includes a liquid crystal panel 16, which is a display panel, and a backlight device (example of illumination device) 24, which is an external light source, these components being maintained in an integrated state with each other by, for example, a bezel 12, which has a frame-like shape. The liquid crystal panel 16 is incorporated into the liquid crystal display device 10 in a posture such that a display surface thereof that is capable of displaying an image faces the front side.

Next, the liquid crystal panel 16 will be described. The liquid crystal panel 16 has a configuration in which a pair of transparent (having a high degree transparency) glass substrates are adhered to each other with a prescribed gap therebetween, and a liquid crystal layer (not illustrated) is enclosed between the glass substrates. One of the glass substrates is, for example, provided with switching elements (for example, TFTs) connected to source wiring lines and gate wiring lines, which orthogonally cross each other, pixel electrodes connected to the switching elements, and an alignment film, and the other of the glass substrates is, for example, provided with a color filter in which colored portions of red (R), green (G) blue (B), etc. are arranged in a prescribed arrangement, an opposite electrode, and an alignment film. Image data and various control signals that are needed to display an image are supplied from a driver circuit substrate, which is not illustrated, to the source wiring lines, gate wiring lines, opposite electrode and so forth among these components. A polarizing plate (not illustrated) is arranged on the outside of both glass substrates.

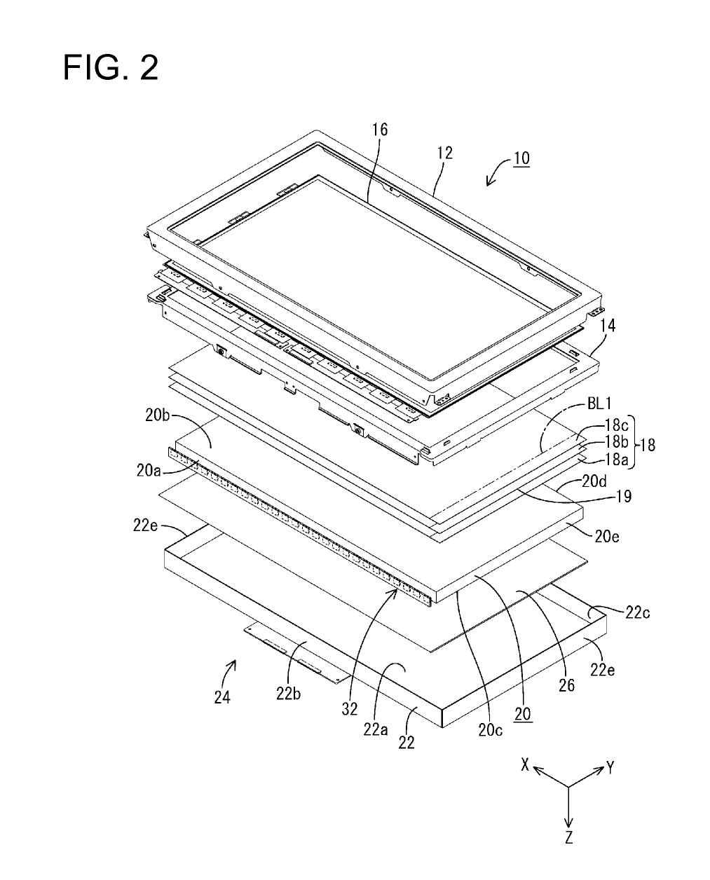

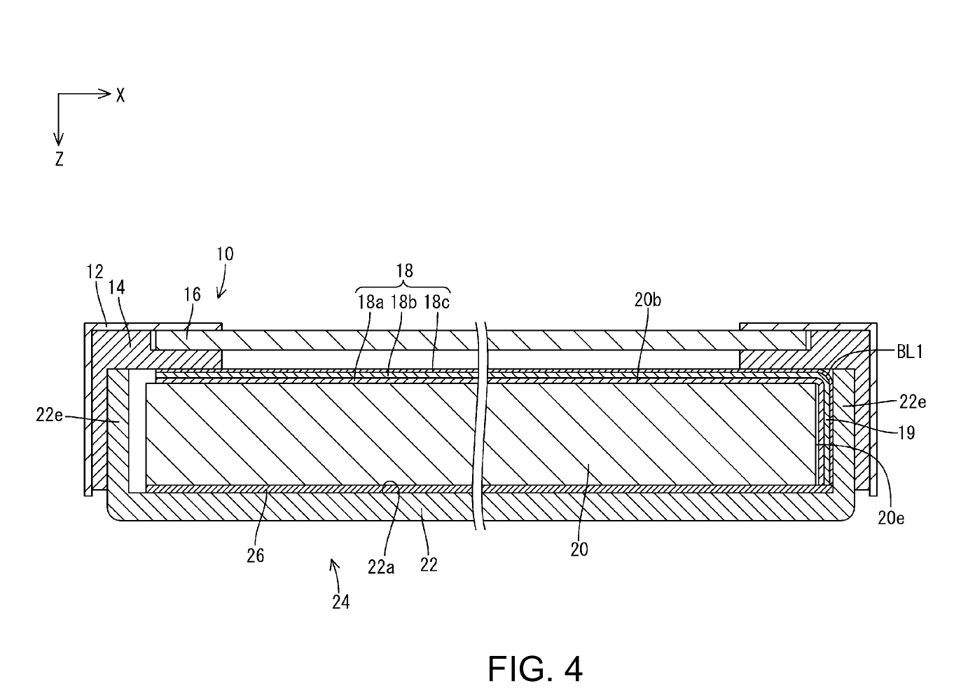

Next, the backlight device 24 will be described. The backlight device 24, as illustrated in FIGS. 2 to 4, includes a chassis (example of housing member) 22 that has a substantially box-like shape that is open toward the front side (light-exiting side, liquid crystal panel 16 side), a frame 14 that is arranged on the front side of the chassis 22, and optical sheets 18 arranged so as to cover an opening of the frame 14. In addition, an LED unit 32 equipped with LEDs 28, which are point light sources, and a light guide plate 20 that guides light from the LED unit 32 to the optical sheets 18 (liquid crystal panel 16) are housed inside the chassis 22. Inside the chassis 22, one side face (light-receiving side face) 20a of the light guide plate 20 on a long-side of the light guide plate 20 is arranged at a position facing the LED unit 32, and light exiting the LED unit 32 is guided toward the liquid crystal panel 16 side. The optical sheets 18 are arranged so as to be spaced apart from a front surface (light-exiting surface 20b) of the light guide plate 20 on the front side of the light guide plate 20. In the backlight device 24 according to this embodiment, the light guide plate 20 and the optical sheets 18 are arranged directly below the liquid crystal panel 16, and the LED unit 32, which is a light source, is arranged at a side end of the light guide plate 20; in other words, an edge-lit scheme (side-lit scheme) is adopted. Hereafter, the constituent components of the backlight device 24 will be described in detail.

The chassis 22 is composed of metal plates such as aluminum plates or electrolytic zinc-coated steel plates (SECC) and, as illustrated in FIGS. 2 to 4, is formed of a bottom plate (example of plate surface) 22a having a horizontally elongated rectangular shape similar to the liquid crystal panel 16, side plates 22b and 22c that stand upright from the two long outer edges of the bottom plate 22a, and side plates 22e and 22e that stand upright from the two short outer edges of the bottom plate 22a. A long-side direction of the chassis 22 (bottom plate 22a) coincides with the X axis direction (horizontal direction) and a short-side direction of the chassis 22 coincides with the Y axis direction (vertical direction). The bottom plate 22a extends parallel to the light guide plate 20 and a reflective sheet 26 housed inside the chassis 22 and supports the light guide plate 20 and the reflective sheet 26 from underneath. A control substrate, which supplies driving signals to the liquid crystal panel 16 and is not illustrated, is affixed to the outside of the back side of the bottom plate 22a. Other substrates such as an LED driving substrate, which supplies driving power to the LED unit 32 and is not illustrated, are affixed to the bottom plate 22a, similar to the control substrate.

The frame 14 is made of a synthetic resin such as a plastic. As illustrated in FIGS. 2 to 4, the frame 14 is formed of a portion that extends parallel to the optical sheets 18 and the light guide plate 20 (liquid crystal panel 16) and is substantially frame-shaped in a plan view, and a portion that protrudes from an outer periphery of the frame-shaped portion toward the back side and has a substantially “L”-like shape. The substantially frame-shaped portion of the frame 14 extends parallel to an outer periphery of the light guide plate 20 and is capable of covering from the front side substantially the entire outer periphery of the optical sheets 18 and the light guide plate 20 arranged on the back side of the frame-shaped portion. On the other hand, the substantially frame-shaped portion of the frame 14 is able to receive (support), from the back side, substantially the entire outer periphery of the optical sheets 18 arranged on the front side of the frame 14. That is, the substantially frame-shaped portion of the frame 14 is arranged so as to be interposed between the optical sheets 18 and the light guide plate 20. In addition, one long-side portion of the substantially frame-shaped portion of the frame 14 covers from the front side both an edge of the light guide plate 20 on the light-receiving side face 20a side and the LED unit 32. The substantially pistol-shaped portion of the frame 14 is attached to the outer surfaces of the side plates 22b and 22c of the chassis 22 in a fitted manner. The outer surface of this portion is arranged so as to abut against an inner surface of a tubular plate surface of the above-mentioned bezel 12.

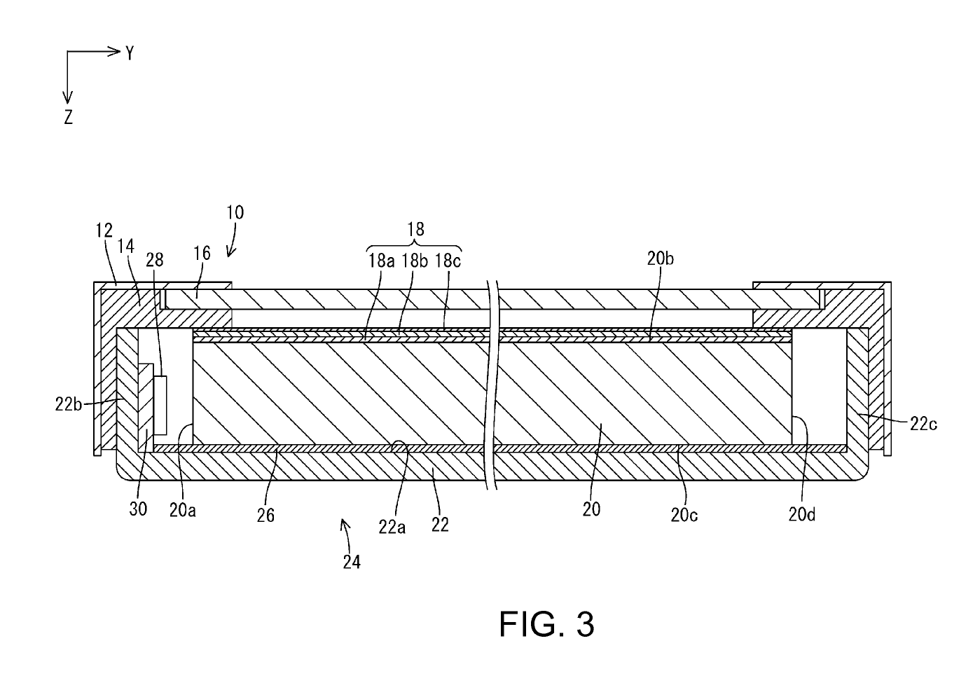

The LED unit 32 has a configuration in which the LEDs 28 are arrayed in a single row on a rectangular LED substrate 30 made of resin. The LED substrate 30, as illustrated in FIG. 2 and FIG. 3, has a long and narrow plate-like shape that extends parallel to a long-side direction (X axis direction) of the chassis 22, and is housed inside the chassis 22 with a posture such that a plate surface thereof is parallel to the X axis direction and the Z axis direction, or in other words, with a posture such that the plate surface thereof is orthogonal to the plate surfaces of the liquid crystal panel 16 and the light guide plate 20. The LED substrate 30 is arranged so as to be adjacent to both side faces (light-receiving side face 20a) of the light guide plate 20 on the long-sides with there being a prescribed gap relative to the light guide plate 20 and is attached to an inner surface of one side plate 22b or 22c on a long-side of the chassis 22. The LEDs 28 are surface mounted on an inner side of the LED substrate 30; that is, on the plate surface facing the light guide plate 20 side, and this is referred to as a mounting surface. A plurality of the LEDs 28 are arranged in a line in a single row (linearly) with there being prescribed gaps therebetween in the length direction of the LED substrate 30 (X axis direction) on the mounting surface of the LED substrate 30. The gaps between the adjacent LEDs 28 in the X axis direction, that is, the arrangement pitch of the LEDs 28, are substantially uniform.

The LEDs 28 each have a configuration in which an LED chip is sealed by a resin material (LED package) on a substrate portion fixed to the LED substrate 30. Each LED chip mounted on the substrate portion has one main emission wavelength, and specifically, an LED chip is used that performs single color emission of blue light. On the other hand, a phosphor that emits light of a certain color when stimulated by blue light emitted from the LED chip is dispersed and mixed into the resin material that seals the LED chip, and consequently the structure as a whole emits substantially white light. As the phosphor, a number of substances may be used by appropriately combining substances from among, for example, a yellow phosphor that emits yellow light, a green phosphor that emits green light, and a red phosphor that emits red light, or just a single one of these substances may be used. The LEDs 28 are so-called top emission type LEDs in which a surface that is on the opposite side to a mounting surface for the LED substrate 30 is a light-emitting surface.

The light guide plate 20 is composed of a synthetic resin material (for example, an acrylic resin such as PMMA or a polycarbonate) having a refractive index that is sufficiently higher than that of air and that is almost completely transparent (excellent transparency). The light guide plate 20, as illustrated in FIG. 2, has a horizontally elongated rectangular shape when viewed in a plan view, similar to the liquid crystal panel 16 and the chassis 22, and is plate shaped with a greater thickness than the optical sheets 18. A long-side direction on the plate surface of the light guide plate 20 coincides with the X axis direction, a short-side direction coincides with the Y axis direction, and a plate-thickness direction that is orthogonal to the plate surface coincides with the Z axis direction. One side face of the light guide plate 20 on a long-side is the light-receiving side face 20a through which light from the LEDs 28 enters. Among the two side faces of the light guide plate 20 on the long-sides, a side face on the opposite side to the light-receiving side face 20a is an opposite side face 20d, and among the two side faces of the light guide plate 20 on the short-sides, a side face that is adjacent to the right side of the light-receiving side face 20a when viewed from the front side is a short-side first side face 20e.

The light guide plate 20, as illustrated in FIGS. 2 to 4, is arranged such that the light-receiving side face 20a is made to face the LED unit 32 and such that the light-exiting surface 20b, which is a main plate surface (plate surface on front side) faces the optical sheets 18 side and an opposite surface 20c, which is a plate surface (plate surface on back side) on the opposite side to the light-exiting surface 20b, faces the reflective sheet 26 side. The light guide plate 20 is supported by the bottom plate 22a of the chassis 22 with the reflective sheet 26 interposed therebetween. That is, the direction in which the light guide plate 20 is lined up with the LED unit 32 coincides with the Y axis direction and the direction in which the light guide plate 20 is lined up with the optical sheets 18 and the reflective sheet 26 coincides with the Z axis direction. In addition to receiving light emitted from the LED unit 32 along the Y axis direction from the light-receiving side face 20a, the light guide plate 20 has a function of causing the light to be directed upward toward the optical sheets 18 side after the light propagates inside the light guide plate 20 and exits from the light-exiting surface 20b.

The reflective sheet 26 has a rectangular sheet-like shape, is made of a synthetic resin, and a surface thereof is of a white color with excellent light reflectivity. A long-side direction of the reflective sheet 26 coincides with the X axis direction, a short-side direction of the reflective sheet 26 coincides with the Y axis direction, and the reflective sheet 26 is arranged so as to be sandwiched between the opposite surface 20c of the light guide plate 20 and the bottom plate 22a of the chassis 22. The reflective sheet 26 has a reflective surface on the front side thereof and this reflective surface is in contact with the opposite surface 20c of the light guide plate 20. The reflective sheet 26 is able to cause light that has leaked from the LED unit 32 or the opposite surface 20c of the light guide plate 20 toward the reflective surface side of the reflective sheet 26 to be reflected. In addition, an edge of the reflective sheet 26 on the light-receiving side face 20a side, as illustrated in FIG. 3, extends so as to contact the LED substrate 30, and as a result light exiting the LEDs 28 and heading directly toward the reflective sheet 26 side can be caused to be reflected toward the light-receiving side face 20a side.

Next, the configuration of the optical sheets 18, which are an important part of this embodiment, will be described in detail. The optical sheets 18 possess flexibility and as illustrated in FIG. 2 have a horizontally elongated rectangular shape when viewed in plan similarly to the liquid crystal panel 16 and the bottom plate 22a of the chassis 22. The optical sheets 18 are made up of a first diffusion sheet 18a, a lens sheet 18b, and a second diffusion sheet 18c stacked on top of one another in order from the light guide plate 20 side. The optical sheets 18 are arranged so as to be interposed between the liquid crystal panel 11 and the light guide plate 20, and as a result the optical sheets 18 cause light exiting the light guide plate 20 to be transmitted therethrough and cause the light to exit toward the liquid crystal panel 16 while applying a certain optical effect such as a convergence effect to the transmitted light. The optical sheets 18 are arranged such that there is slight gap between the optical sheets 18 and the liquid crystal panel 16. Furthermore, a bent portion 19 that extends further toward the outside than the light-exiting surface 20b of the light guide plate 20 is provided at one of the edges on the short-sides among the edges of each optical sheet 18. In each of the optical sheets 18, a first bending line BL1 as illustrated in FIG. 2 is provided between the bent portion 19 and the remaining portion (portion superposed with light-exiting surface 20b) of the optical sheet 18. In the backlight device 24 of this embodiment, the bent portions 19 of the optical sheets 18 can be bent toward the opposite surface side of the light guide plate 20 (bottom plate 22a side of chassis 22) along the first bending lines BL1 during the manufacturing process.

As a result of the bent portions 19 of the optical sheets 18 being bent along the first bending lines BL1 toward the opposite surface 20c side of the light guide plate 20, the bent portions 19 come to be arranged between the short-side first side face 20e of the light guide plate 20 and one short-side side plate 22e of the chassis 22. The bent portions 19 each extend from the entire length of the edge of the corresponding optical sheet 18 on the short-side. The leading edges of the bent portions 19 extend so as to contact the reflective sheet 26. Consequently, the bent portions 19 cover the entirety of the short-side first side face 20e of the light guide plate 20. Furthermore, the bent portions 19 of the optical sheets 18 are arranged between and therefore interposed between the short-side first side face 20e of the light guide plate 20 and the one short-side side plate 22e of the chassis 22. Thus, the bent portions 19 of the optical sheets 18 are maintained in a state of being bent along the first bending lines BL1. Since the bent portions 19 are interposed between the two members in this way, there is no need to provide a large space in which to house the bent portions 19 in the planar direction (toward outside of light guide plate 20). Consequently, the border of the backlight device 24 can be made slim.

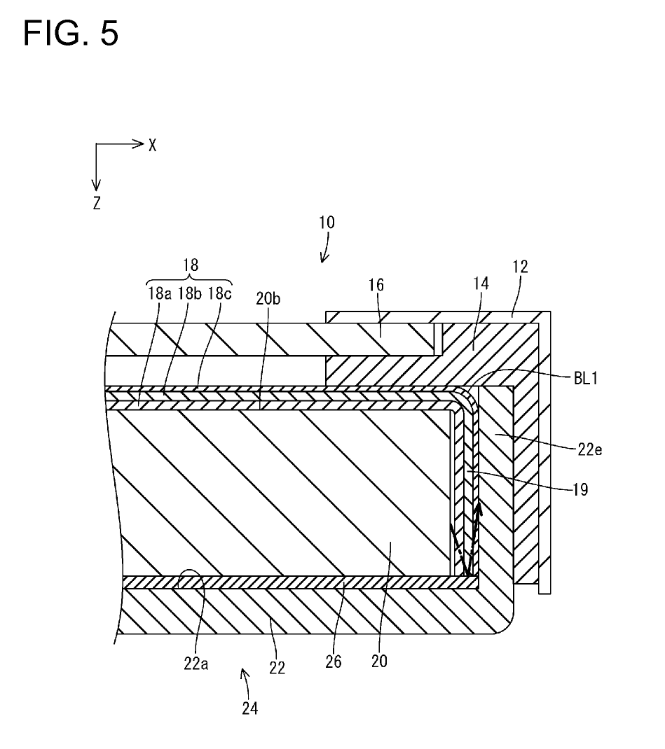

Next, the reflection of light heading toward side faces of the bent portions 19 from light introduced into the optical sheets 18 after exiting the light-exiting surface 20b of the light guide plate 20 will be described with reference to FIG. 5. Light heading toward side faces of the bent portions 19 from light introduced into the optical sheets 18 after exiting the light-exiting surface 20b of the light guide plate 20 is reflected at leading edges (side faces) of the bent portions 19. Here, the bent portions 19 are positioned between the short-side first side face 20e of the light guide plate 20 and the side plate 22e of the chassis 22 and therefore light reflected at a side face of the bent portions 19 heads toward a side surface of the side plate 22e of the chassis 22 (refer to arrow illustrated by single-dot chain line in FIG. 5). Consequently, there is no risk of light reflected at a side face of the bent portions 19 leaking toward the liquid crystal panel 16 side, and the generation of bright lines on the display surface of the liquid crystal panel 16 due to such reflected light is prevented.

In the above-described backlight device 24 according to this embodiment, since the bent portions 19 of the optical sheets 18 are bent over toward the opposite surface 20c side, even if light that has exited the light-exiting surface 20b of the light guide plate 20 is reflected at a side face of the bent portions 19, the reflected light does not head toward the light-exiting surface 20b side of the backlight device 24 (liquid crystal panel 16 side) but instead heads toward the side of the backlight device 24. Consequently, generation of bright lines caused by the reflected light at an edge of the liquid crystal panel 16 can be prevented or suppressed. Furthermore, in the backlight device 24 according to this embodiment, since the bent portions 19 are bent over toward the opposite surface 20c side of the light guide plate 20, there is no need to provide extra space in which to arrange the bent portions 19 on the outer side of the light guide plate 20. Consequently, the border of the backlight device 24 can be made slim. As described above, in the backlight device 24, a slim border can be achieved while preventing or suppressing generation of bright lines on the display surface of the liquid crystal panel 16 caused by light reflected at a side face of the optical sheets 18.

Furthermore, in the backlight device 24 according to this embodiment, the bent portions 19 may cover the entirety of the one side face 20e of the light guide plate 20. By adopting this configuration, a greater amount of light out of light heading toward a side face of the optical sheets 18 after exiting the light-exiting surface 20b of the light guide plate 20 can be made to head toward a side face of the bent portions 19. Thus, reflection of light at a side face of the optical sheets 18 can be more effectively prevented or suppressed.

In this embodiment, the bent portions 19 are bent so as to face the short-side first side face 20e of the light guide plate 20 rather than the opposite side face 20d of the light guide plate 20. Here, since the distance from the LEDs 28 to the short-side first side face 20e is shorter than that to the opposite side face 20d, a greater amount of light reaches the first side face 20e from the LEDs 28. Therefore, a greater amount of light can be caused to be reflected at a side face of the bent portions 19 and the generation of bright lines on the display surface of the liquid crystal panel 16 caused by light reflected at a side face of the optical sheets 18 can be more effectively prevented or suppressed with the backlight device 24 of this embodiment compared with a configuration in which the bent portions 19 are bent so as to face the opposite side face 20d.

### Modification Example of Embodiment 1

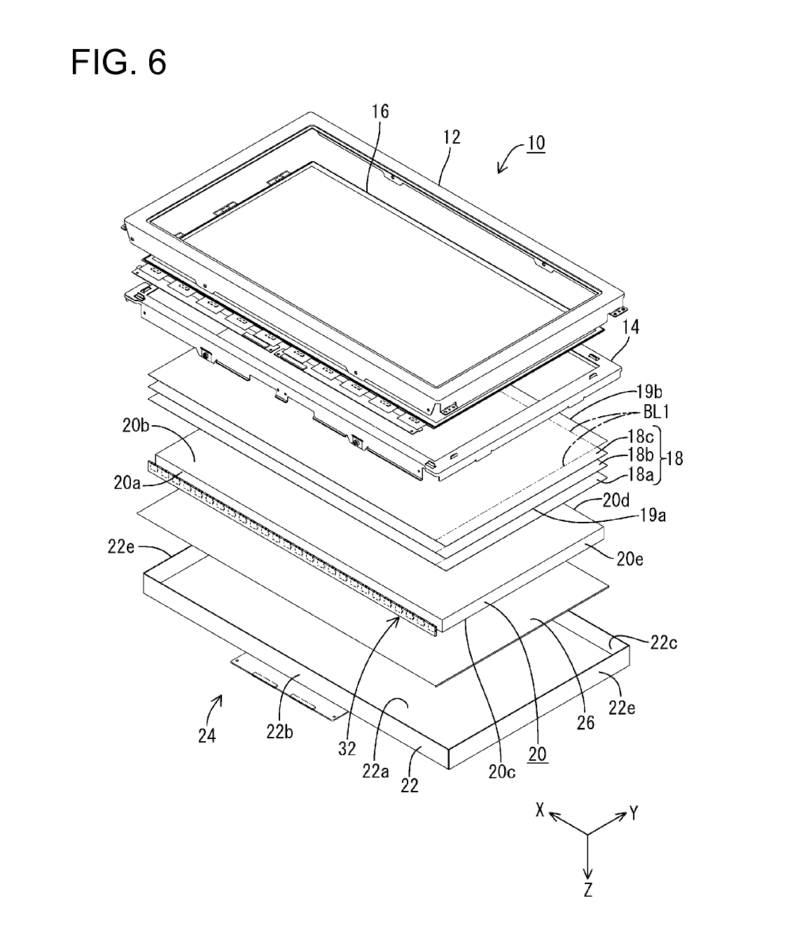

Next, a modification example of Embodiment 1 will be described. This modification example differs from Embodiment 1 in that bent portions 19a and 19b are provided at two places in each of the optical sheets 18. The rest of the configuration is the same as that of Embodiment 1 and therefore description of the structure, operation and effect will be omitted. In a backlight device 24 according to this modification example, as illustrated in FIG. 6, the bent portions 19a and 19b, which extend further toward the outside than the light-exiting surface 20b of the light guide plate 20, are provided at one edge on a short-side and one edge on a long-side among edges of each optical sheet 18. The bent portions 19a and 19b are bent along first bending lines BL1 so as to face the short-side first side face 20e and the opposite side face 20d of the light guide plate.

Here, in order to make a greater amount of light from the light heading toward side faces of the optical sheets 18 head toward side faces of the bent portions 19a and 19b, it is preferable that the bent portions 19a and 19b be provided at each edge of the optical sheets 18. However, if a bent portion were provided at each edge of the optical sheets 18, it would be likely that wrinkles would occur in the vicinity of the bent portions 19a and 19b at the time of thermal expansion and contraction of the optical sheets 18, for example. Consequently, it is preferable that the bent portions 19a and 19b not be provided on the edges on the opposite sides to the edges at which the bent portions 19a and 19b are provided in the optical sheets 18 in order to eliminate such wrinkles. With the configuration of this modification example, the bent portions 19a and 19b are arranged in two places so as to respectively face the short-side first side face 20e and the opposite side face 20d of the light guide plate 20, and therefore both a configuration for causing a greater amount of light to head toward side faces of the bent portions 19a and 19b and a configuration for eliminating wrinkles generated at, for example, the time of thermal expansion and contraction, can be realized.

### Embodiment 2

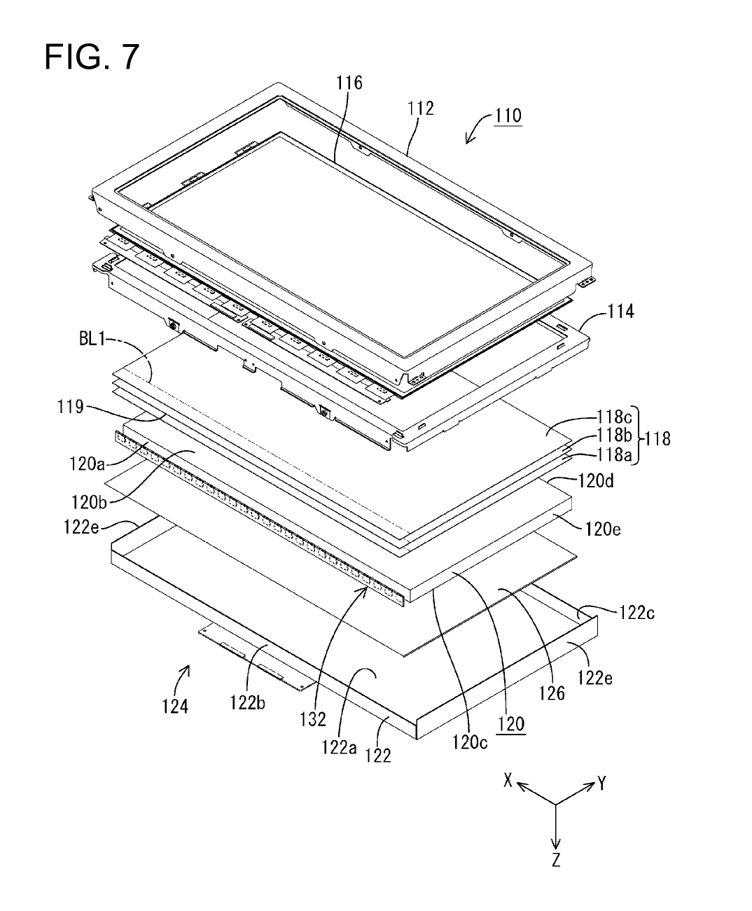

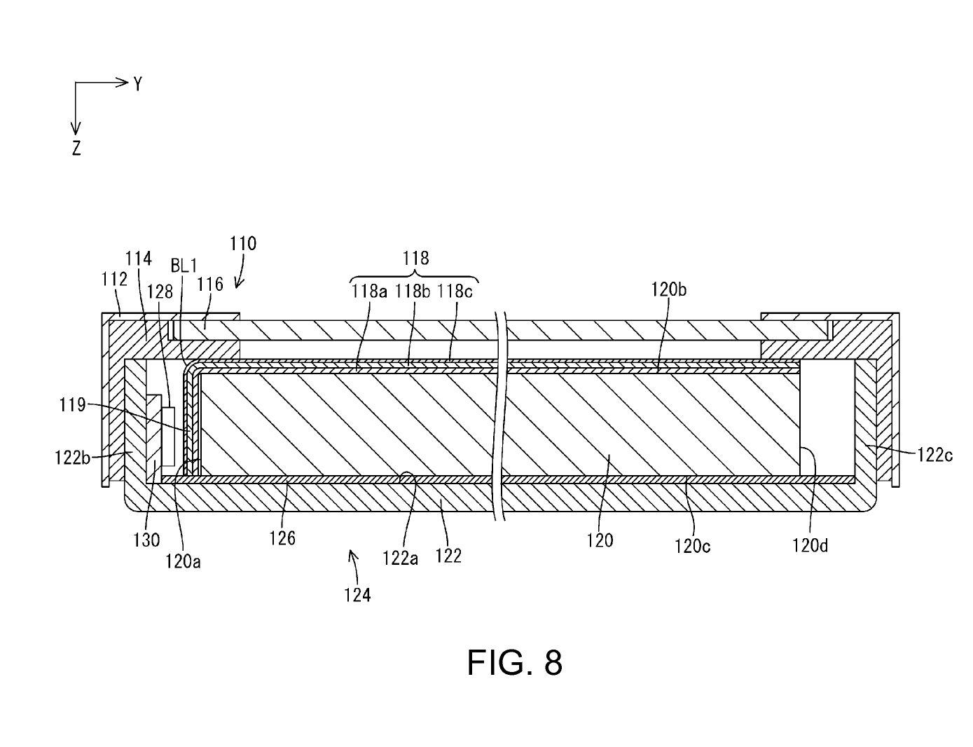

Embodiment 2 will be described while referring to the drawings. The arrangement of bent portions 119 is different in Embodiment 2 compared with Embodiment 1. The rest of the configuration is the same as that of Embodiment 1 and therefore description of the structure, operation and effect will be omitted. In addition, in FIG. 7 and FIG. 8, portions that have had 100 added to the corresponding reference symbols in FIGS. 2 and 3 are the same as the portions described in Embodiment 1.

In a backlight device 124 according to Embodiment 2, as illustrated in FIG. 7, a bent portion 119 extends from one edge on a long-side (edge on light-receiving side face 120a side) among edges of each optical sheet 118 and the bent portions 119 extend in an arrangement so as to face the light-receiving side face 120a of a light guide plate 120. Each bent portion 119 of this embodiment extends from the entire length of the edge of the corresponding optical sheet 118 on the light-receiving side face 120a side, extends toward a bottom plate 122a side of a chassis 122 beyond a position facing light-emitting surfaces of LEDs 128, and a leading edge thereof contacts a reflective sheet 126. Consequently, the bent portions 119 are bent along first bending lines BL1 toward an opposite surface 120c side of the light guide plate 120, and as a result come to be arranged between the light-receiving side face 120a of the light guide plate 120 and the LEDs 128 (LED substrate 130). Furthermore, as a result of adopting this configuration, the bent portions 119 cover the entirety of the light-receiving side face 120a of the light guide plate 120.

In this embodiment, light heading toward the light-receiving side face 120a after exiting the LEDs 128 is transmitted through the bent portions 119 of the optical sheets 118 and then enters the light-receiving side face 120a. At this time, the light is transmitted through the bent portions 119 in an order opposite to that in which light entering the optical sheets 118 after exiting a light-exiting surface 120b of the light guide plate 120 is transmitted through the optical sheets 118; that is, the light is transmitted through the bent portions 119 in the order of a second diffusion sheet 118c, a lens sheet 118b and a first diffusion sheet 118a. Here, as described in Embodiment 1, light introduced into the optical sheets 118 after exiting the light-exiting surface 120b of the light guide plate 120 is transmitted through the optical sheets 118 in the order of the first diffusion sheet 118a, the lens sheet 118b and the second diffusion sheet 118c and thereby a convergence effect is applied to the light. In contrast, light heading toward the light-receiving side face 120a after exiting the LEDs 128 is transmitted through the bent portions of the optical sheets 118 in an order opposite to the above-described order and therefore an effect that is the reverse of the convergence effect, that is, a diffusion effect is applied to the light.

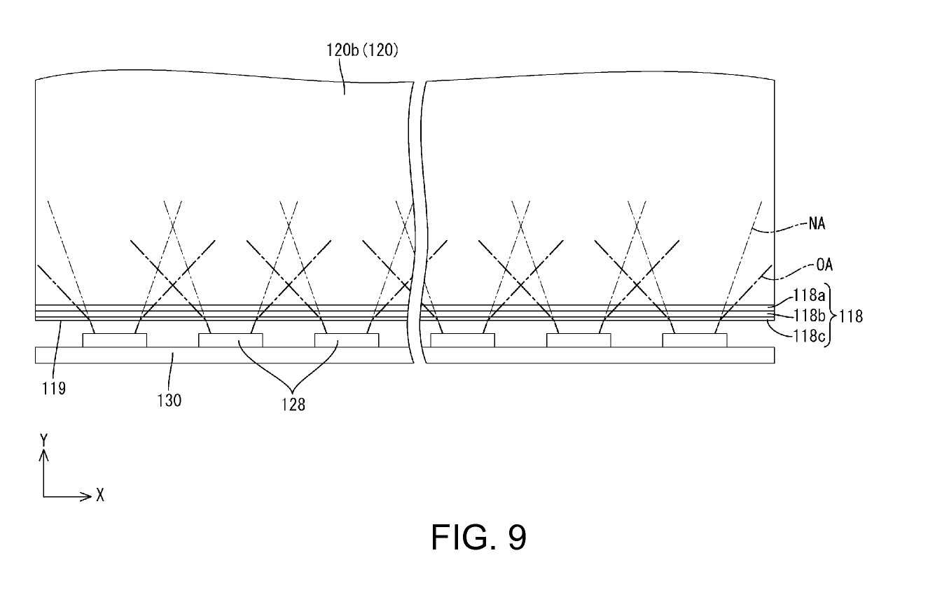

Here, the coverage inside the light guide plate 120 of light that has entered from the light-receiving side face 120a after exiting the LEDs 128 is illustrated in FIG. 9. In FIG. 9, a relatively narrow single-dot chain line represents coverage OA inside the light guide plate 120 of light that has entered the light-receiving side face 120a without being transmitted through the bent portions 119 after exiting the LEDs 128. On the other hand, in FIG. 9, a relatively thick single-dot chain line represents coverage NA inside the light guide plate 120 of light that has entered the light-receiving side face 120a after exiting the LEDs 128 and being transmitted through the bent portions 119. As illustrated in FIG. 9, the light that has been transmitted through the bent portions 119 after exiting the LEDs 128 is diffused over a wider range inside the light guide plate 120 compared with the case where the light is not transmitted through the bent portions 119. Consequently, uneven brightness in the vicinity of the light-receiving side face 120a side of the light guide plate 120 (caused by portions facing the LEDs 128 in the vicinity of the light-receiving side face 120a being displayed relatively brightly and portions not facing the LEDs 128 in the vicinity of the light-receiving side face 120a being displayed relatively darkly) is prevented or suppressed.

As described above, in the backlight device 124 according to this embodiment, the bent portions 119 are arranged on the light-receiving side face 120a side among side faces of the light guide plate 120. As a result of adopting this configuration, light heading toward the light-receiving side face 120a after exiting the LEDs 128 is transmitted through the bent portions 119. At this time, light that is transmitted through the bent portions 119 enters the optical sheets 118 from the opposite side to the side from which light that has exited the light-exiting surface 120b enters. Here, the optical sheets 118 having the bent portions 119 cause light that has exited the light-exiting surface 120b of the light guide plate 120 to converge. Consequently, light that has been transmitted through the bent portions 119 from light heading toward the light-receiving side face 120a after exiting the LEDs 128 is diffused, and as a result, uneven brightness on the light-receiving side face 120a side of the light guide plate 120 can be prevented or suppressed.

In addition, in the backlight device 124 according to this embodiment, the bent portions 119 arranged on the light-receiving side face 120a side extend toward the bottom plate 122a side of the chassis 122 beyond a position facing the light-emitting surfaces of the LEDs 128. As a result of this configuration being adopted, the majority of the light heading toward the light-receiving side face 120a after exiting the LEDs 128 is transmitted through the bent portions 119; therefore, the light heading toward the light-receiving side face 120a after exiting the LEDs 128 can be effectively diffused. Thus, uneven brightness on the light-receiving side face 120a side of the light guide plate 120 can be prevented or suppressed to a greater degree.

### Embodiment 3

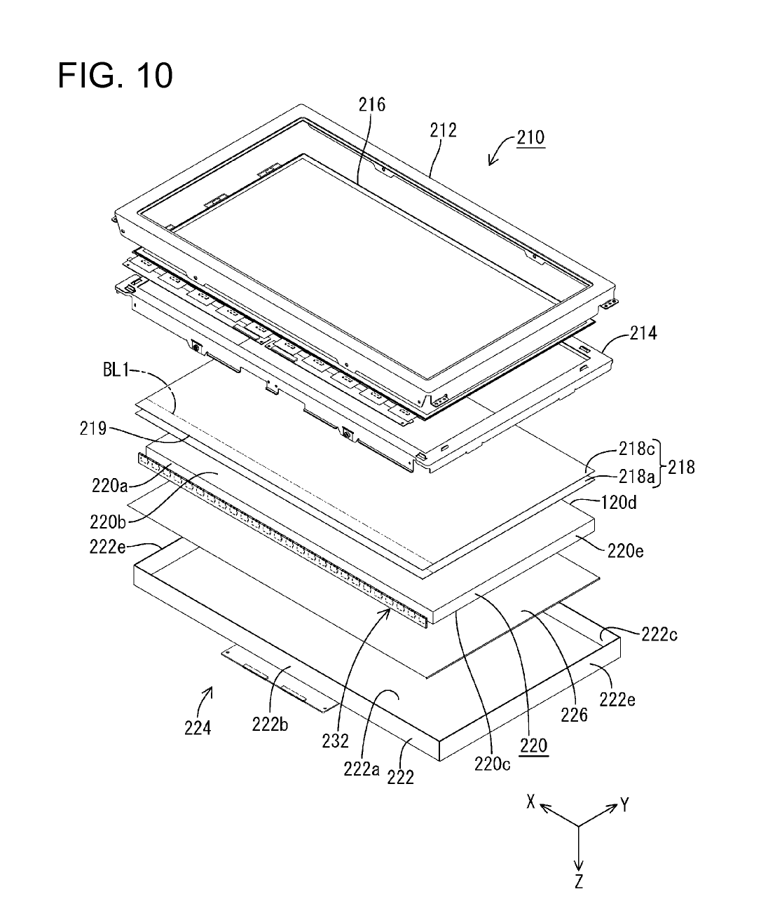

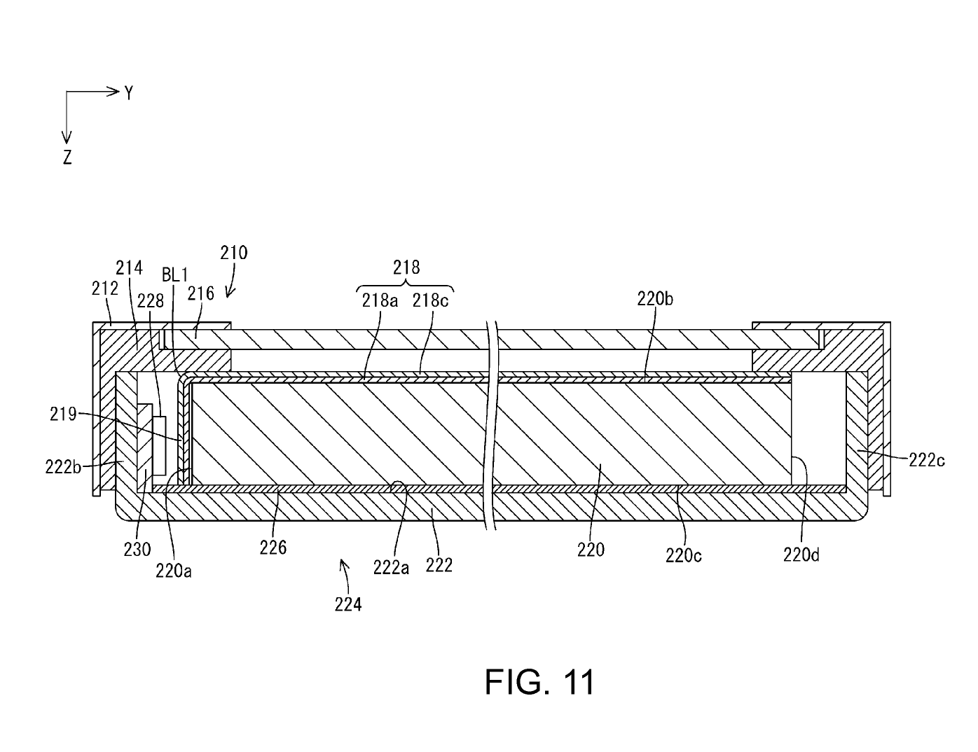

Embodiment 3 will be described while referring to the drawings. The configuration of optical sheets 218 in Embodiment 3 is different from those in Embodiment 1 and Embodiment 2. The rest of the configuration is the same as that of Embodiment 1, and therefore description of the structure, operation, and effect will be omitted. In addition, in FIGS. 10 and 11, portions that have had 100 added to the corresponding reference symbols in FIGS. 7 and 8 are the same as the portions described in Embodiment 1 and Embodiment 2.

In a backlight device 224 according to Embodiment 3, as illustrated in FIGS. 10 and 11, a configuration is adopted in which bent portions 219 are arranged on a light-receiving side face 220a side among side faces of a light guide plate 220 similar to the configuration in Embodiment 2. In addition, the manner in which the bent portions 219 extend is the same as in the configuration of Embodiment 2. In this embodiment, optical sheets 218 have a configuration obtained by removing the lens sheet from the optical sheets in Embodiment 1 and Embodiment 2; that is, the optical sheets are made up of only two sheets, or namely, a first diffusion sheet 218a and a second diffusion sheet 218c.

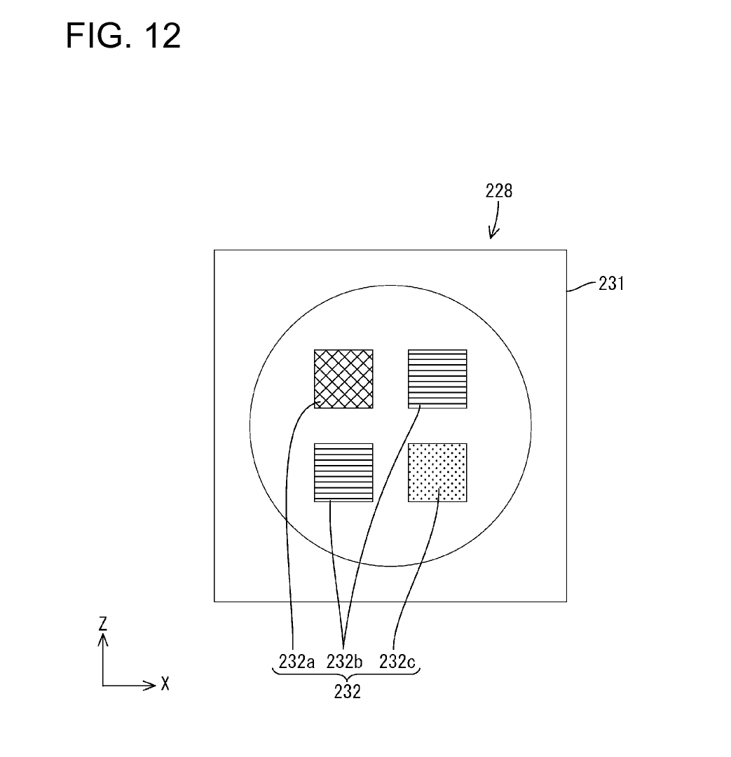

Furthermore, in this embodiment, as illustrated in FIG. 12, a configuration is adopted in which four LED chips 232 are arranged at regular intervals and housed inside an LED package 231, and such an LED package 231 forms each LED 228. Specifically, one LED chip 232a that performs single color emission of red light, two LED chips 232b that perform single color emission of green light, and one LED chip 232c that performs single color emission of blue light are housed inside the LED package 231. In a configuration in which a plurality of LED chips that perform single color light emission of different colors are housed in each of the LEDs 228 in this way, single color light emitted from each of the LED chips 232a, 232b, and 232c has to be caused to mix together while propagating inside the light guide plate 220, and a certain optical path length needs to be secured for the light propagating inside the light guide plate 220. Therefore, there is a risk of color unevenness being generated by the plurality of single colors of light having different colors emitted from the LED chips 232a, 232b, and 232c in the vicinity of the LEDs 228.

In contrast, in this embodiment, light that has exited the LEDs 228 is transmitted through the bent portions 219 and then enters the light-receiving side face 220a of the light guide plate 220. Here, in this embodiment, a configuration is adopted in which the optical sheets 218 are composed of only the first diffusion sheet 218a and the second diffusion sheet 218c as described above, and with this configuration, light that has been transmitted though the optical sheets 218 (from the second diffusion sheet 218c side) can be caused to be diffused with a higher angular distribution as a result of a lens sheet 218b having been removed compared with a configuration in which the lens sheet 218b is interposed between the two diffusion sheets 218a and 218c. Thus, in this embodiment, light that has entered the light-receiving side face 220a of the light guide plate 220 after being transmitted through the bent portions 219 is diffused over a wider area inside the light guide plate 220 compared to the configuration of Embodiment 2. Consequently, even with a configuration in which a plurality of single color light emission LED chips 232a, 232b, and 232c that emit light of different colors are housed in each LED 228, it is possible to cause single color light emitted from the LED chips 232a, 232b, and 232c to be mixed at a short optical path length inside the light guide plate 220. Thus, in this embodiment, color unevenness can be eliminated.

### Embodiment 4

Embodiment 4 will be described while referring to the drawings. Embodiment 4 is different from Embodiments 1 to 3 in that a module forms a backlight device 324 and a liquid crystal display device 310, and in terms of the configuration of bent portions 319. In Embodiment 4, a liquid crystal display device 310 is exemplified that is smaller than those of Embodiments 1 to 3 and that is to be used in a variety of electronic appliances such as portable information terminals (cellular phones, smartphones, tablet-type notebook computers, and so on), in-vehicle information terminals (non-portable car navigation systems, portable car navigation systems, and so on) and portable games consoles.

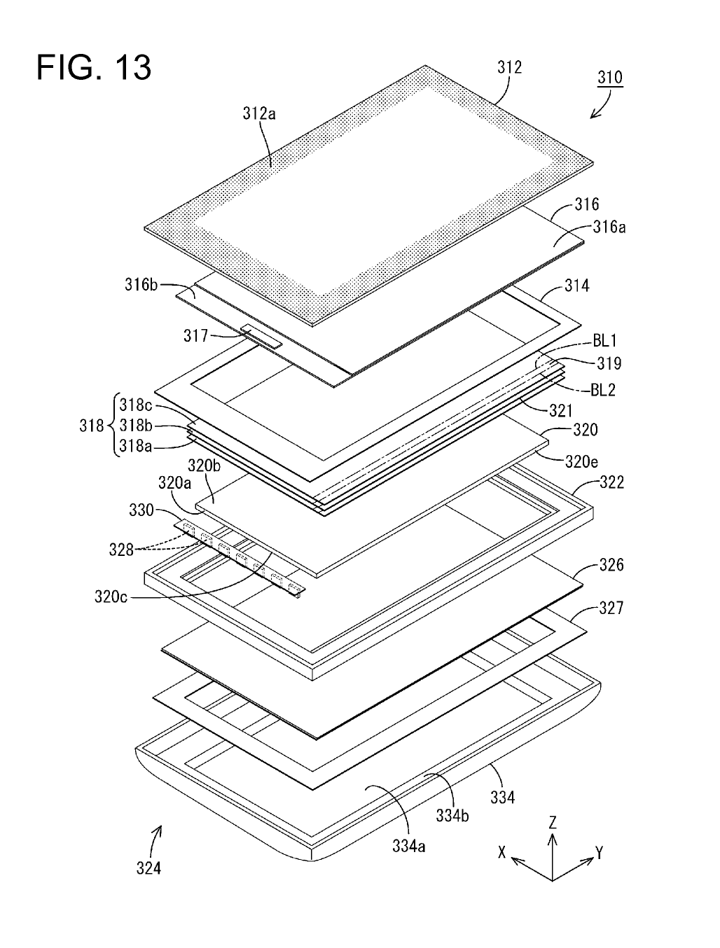

The liquid crystal display device 310 according to this embodiment, as illustrated in FIG. 13, has a vertically elongated rectangular shape as a whole and includes a liquid crystal panel 316 having a front side plate surface serving as a display surface on which an image is displayed, a cover panel 312 arranged so as to face the display surface of the liquid crystal panel 316, and the backlight device 324, which is an external light source that is arranged on the opposite side of the liquid crystal panel 316 to the cover panel 312 and that supplies light to the liquid crystal panel 316. In addition, the liquid crystal display device 310 includes a casing (example of a housing member) 334 that houses the cover panel 312, the liquid crystal panel 316, and the backlight device 324. Among the constituent components of the liquid crystal display device 310, the cover panel 312 and the casing 334 form the exterior of the liquid crystal display device 310. The liquid crystal display device 310 according to this embodiment is to be used in a small-sized terminal as described above, and therefore the screen size of the liquid crystal panel 316 and the cover panel 312 of the liquid crystal display device 310 is on the order of several inches to around 10 inches, and is a size that is generally classified as small-sized or small/medium-sized.

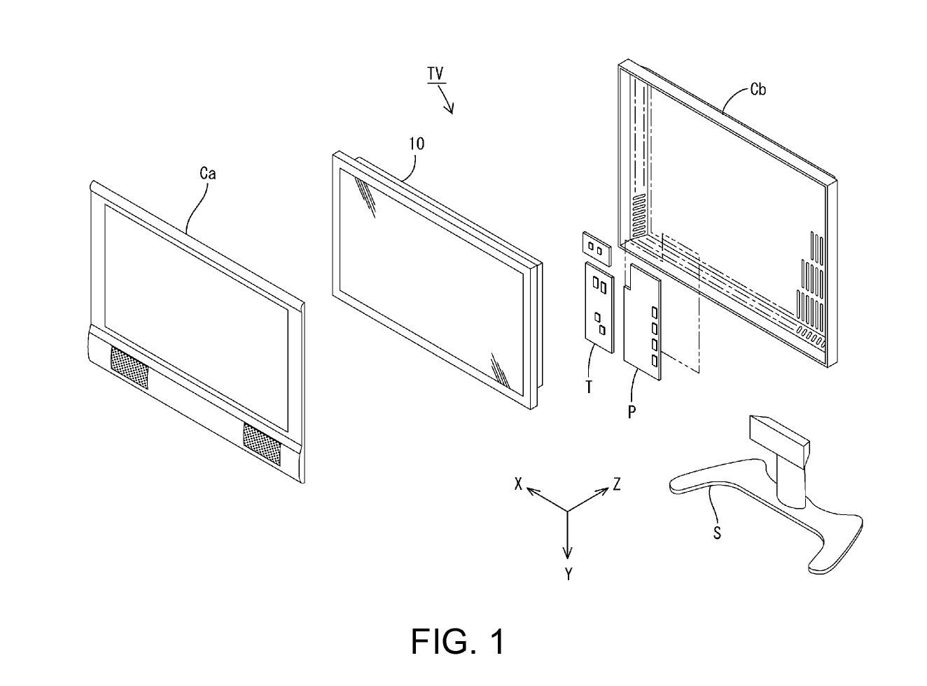

First, the liquid crystal panel 316 will be described. The liquid crystal panel 316, as illustrated in FIG. 13, has a vertically elongated rectangular shape on the whole and includes a pair of transparent (having a high degree of transparency) glass substrates 316a and 316b and a liquid crystal layer (not illustrated) that is interposed between the substrates 316a and 316b and that contains liquid crystal molecules, which form a substance having optical characteristics that change in accordance with an applied electric field. The substrates 316a and 316b are adhered to each other using a sealing agent, which is not illustrated, with a gap equal to the thickness of the liquid crystal layer being maintained therebetween. Among the substrates 316a and 316b, a substrate on the back side (rear surface side) is an array substrate 316b and a substrate on the front side (front surface side) is a CF substrate 316a. The array substrate 316b is, for example, provided with switching elements (for example, TFTs) connected to source wiring lines and gate wiring lines, which orthogonally cross each other, pixel electrodes connected to the switching elements, and an alignment film. The CF substrate 316a is, for example, provided with a color filter in which colored portions of red (R), green (G), blue (B), etc. are arranged in a certain arrangement, an opposite electrode, and an alignment film. Here, as illustrated in FIG. 1, the CF substrate 316a has a short-side dimension that is substantially the same as that of the array substrate 316b but a long-side dimension that is smaller than that of the array substrate 316b, and the CF substrate 316a is adhered to the array substrate 316b such that the substrates are aligned with each other at one end thereof in the long-side direction. Therefore, both the front and back plate surfaces of the array substrate 316b at the other end in the long-side direction are exposed to the outside, and a mounting region for a driver 317 for driving the liquid crystal panel 316 and for a panel-side flexible substrate (not illustrated) is secured here. Thus, image data and various control signals that are needed to display an image are supplied from a driver circuit substrate, which is not illustrated, to the source wiring lines, gate wiring lines, and opposite electrode. A polarizing plate (not illustrated) is arranged on the outside of both substrates.

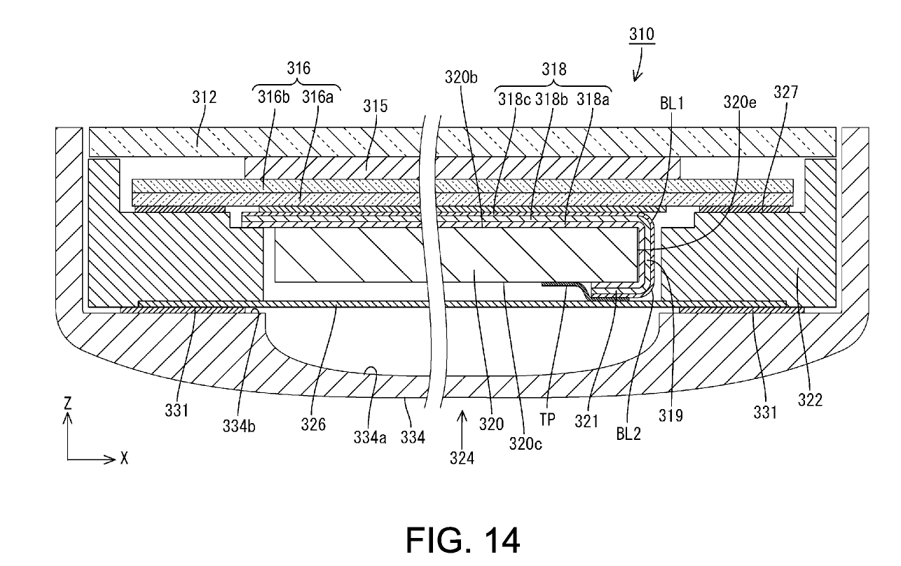

The cover panel 312 is arranged so as to cover the entirety of the liquid crystal panel 316 from the front side, and thus is able to protect the liquid crystal panel 316. The liquid crystal panel 316 is adhered to the central portion of a back-side plate surface of the cover panel 312 with an adhesive 315 (refer to FIG. 14). The cover panel 312 has a vertically elongated rectangular shape similar to the liquid crystal panel 316, and the peripheral size thereof when viewed in a plan view is larger than those of the substrates 316a and 316b, which make up the liquid crystal panel 316, and substantially the same as that of the outer shape of a frame 322, which will be described later. Therefore, an outer peripheral portion of the cover panel 312 extends toward the outside beyond an outer periphery of the liquid crystal panel 316 in an eaves-like manner. A light-shielding portion 312a that blocks light around the periphery of the cover panel 312 is formed in the cover panel 312. The light-shielding portion 312a is provided by performing printing, such as screen printing or inkjet printing. By forming the light-shielding portion 312a in an outer peripheral portion that extends further toward the outside than an outer periphery of the liquid crystal panel 316, the light-shielding portion 312a is formed in a vertically elongated substantially frame-like shape (substantially picture-frame-like shape), and as a result light from the backlight device 324 can be blocked by the light-shielding portion 312a before entering a back-side plate surface of the cover panel 312 around the periphery of the liquid crystal panel 316.

The casing 334 is formed of a synthetic resin material or a metal material, and as illustrated in FIG. 1, is substantially shaped like a bowl that is open toward the front side. The cover panel 312, the liquid crystal panel 316, and the backlight device 324 are housed inside a housing space occupying the inside of the casing 334. Therefore, the casing 334 covers the backlight device 324 from the back side and covers the entire peripheries of the backlight device 324 and the cover panel 312 from the side, and as a result forms the rear-surface-side and side-surface-side exterior of the liquid crystal display device 310. Furthermore, an outer peripheral portion of the casing 334 has a substantially staircase-like shape formed from two steps and includes a lowest first step 334a (example of plate surface) and a next lowest second step 334b. Casing adhesive tape 331 (refer to FIG. 14) for adhering the second step 334b of the casing 334 and a back-side surface of the frame 322 to each other is arranged so as to be interposed between the second step 334b facing the frame 322 of the backlight device 324 and the back-side surface of the frame 322, and the casing 334 and the frame 322 are maintained in a state of being attached to each other by the casing adhesive tape 331. In addition, various substrates, which are not illustrated, such as a control substrate for controlling driving of the liquid crystal panel 316 and an LED driving substrate for supplying driving power to LEDs 328 are housed in the remaining space between the first step 334a of the casing 334 and the back side of the backlight device 324.

Next, the backlight device 324 will be described. The backlight device 324 includes LEDs 328, a flexible substrate 330 on which the LEDs 328 are mounted and that possesses flexibility, a light guide plate 320 that guides light from the LEDs 328, optical sheets 318 stacked and arranged on top of the light guide plate 320, a reflective sheet 326 stacked and arranged underneath the light guide plate 320, and the frame-shaped frame 322 that surrounds the light guide plate 320 and the optical sheets 318 and supports the liquid crystal panel 316 from the back side (side opposite to cover panel 312 side). The backlight device 324 is arranged such that the LEDs 328 are located at an outer peripheral end of the liquid crystal panel 316; that is, the backlight device 324 is a so-called edge-lit-type (side-lit-type) backlight device.

The configurations of the light guide plate 320, the reflective sheet 326, and the LEDs 328 are the same as those of Embodiment 1, and therefore a description thereof will be omitted. The flexible substrate 330 is formed of a film-shaped base material composed of a synthetic resin material having an insulating property and flexibility (for example, a polyimide-based resin), and is arranged in the vicinity of an end of the light guide plate 320 on a light-receiving side face 320a side. The flexible substrate 330 has a horizontally elongated rectangular shape when viewed in a plan view, a long-side direction thereof coincides with an X axis direction, and a short-side direction thereof coincides with a Y axis direction. A front surface of the flexible substrate 330 is arranged so as to be on the liquid crystal panel 316 side (front side), and a surface of the flexible substrate 330 that faces the reflective sheet 326 side is a mounting surface on which the LEDs 328 are mounted. Another edge of the flexible substrate 330 that forms a long-side is mounted on the frame 322, which will be described next, and is thereby supported by the frame 322. A plurality of the LEDs 328 are mounted in a line in a long-side direction (X axis direction) of the flexible substrate 330 on the mounting surface of the flexible substrate 330. The LEDs 328 are so-called side-emission-type LEDs and are mounted in a line on the mounting surface of the flexible substrate 330 such that the light-emitting surfaces thereof face the light-receiving side face 320a side of the light guide plate 320.

The frame 322 is made of a synthetic resin, and as illustrated in FIG. 13, has a vertically elongated substantially frame-like shape having an outer shape substantially the same as that of the cover panel 312, and houses therein the liquid crystal panel 316, the light guide plate 320, and the optical sheets 318. In the frame 322, a pair of short-side portions that extend in the X axis direction and a pair of long-side portions that extend in the Y axis direction are connected together. The frame 322 faces an outer periphery of the cover panel 312 where the light-shielding portion 312a is formed and a back-side plate surface of the liquid crystal panel 316, and is able to support this plate surface from the back side along the whole periphery thereof. The frame 322 has a substantially staircase-like cross-sectional shape formed from three steps. The lowest step supports one edge of the flexible substrate 330 forming a long-side, the second lowest step supports from the back side one edge of the optical sheets 318 and an outer periphery of the liquid crystal panel 316, and the highest step supports from the back side an outer periphery of the cover panel 312.

In this embodiment, as illustrated in FIGS. 13 and 14, a configuration is adopted in which the optical sheets 318 are stacked in the order of a first diffusion sheet 318a, a lens sheet 318b, and a second diffusion sheet 318c from the light guide plate 320 side, similar to in Embodiment 1. Furthermore, a bent portion 319 that extends further toward the outside than a light-exiting surface 320b of the light guide plate 320 is provided at one of the edges on the short-sides among the edges of the optical sheets 318. The bent portions 319 are bent along first bending lines BL1 toward an opposite surface 320c side of the light guide plate 320, and thus the bent portions 319 come to be arranged between a short-side first side face 320e of the light guide plate 320 and the frame 322. The bent portions 319 are interposed between the short-side first side face 320e of the light guide plate 320 and the frame 322 similar to in Embodiment 1, and as a result a state of being bent along the first bending lines BL1 is maintained.

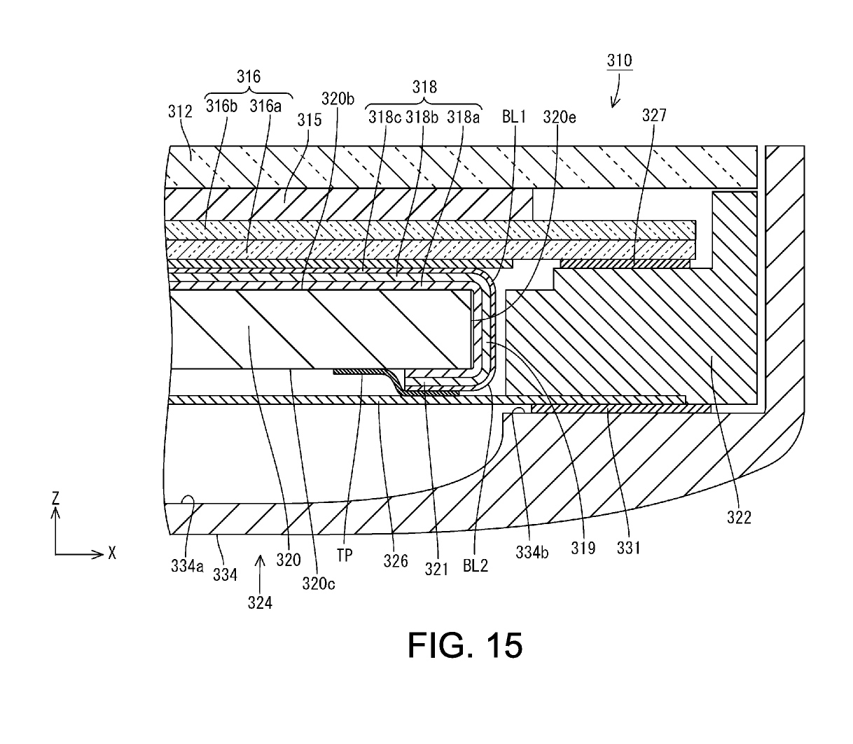

Furthermore, in this embodiment, leading ends of the bent portions 319 extend to the opposite surface 320c side of the light guide plate 320 and are bent along second bending lines BL2 so as to face the opposite surface 320c side, and as a result cover part of the opposite surface 320c (hereinafter, the portions of the bent portions 319 that cover part of opposite surface 320c will be called “opposite surface covering portions 321”). The opposite surface covering portions 321 extend from the entire length of the edges of the bent portions 319 and are interposed between the opposite surface 320c and the reflective sheet 326, and as a result a state of the opposite surface covering portions 321 being bent along the second bending lines BL2 is maintained. In addition, the opposite surface covering portions 321, as illustrated in FIG. 15, as well as covering part of the opposite surface 320c, are in contact with the part of the opposite surface 320c and are fixed to the opposite surface 320c with adhesive tape TP.

Thus, in this embodiment, as well as extending to the opposite surface 320c side of the light guide plate 320, the bent portions 319 have opposite surface covering portions 321 that cover part of the opposite surface 320c. As a result of adopting this configuration, portions of the bent portions 319 that extend to the opposite surface 320c side can be interposed between the light guide plate 320 and the reflective sheet 326, and a state in which the bent portions 319 including the opposite surface covering portions 321 are bent can be effectively maintained.

In addition, in this embodiment, a configuration is adopted in which the opposite surface covering portions 321 are fixed to the opposite surface 320c by adhesive tape TP. Thus, by fixing the opposite surface covering portions 321 to the light guide plate 320 with the adhesive tape TP, the state in which the bent portions 319 including the opposite surface covering portions 321 are bent can be maintained more effectively.

In a configuration in which the bent portions 319 are fixed to the light guide plate 320 using the adhesive tape TP, as in this embodiment, there is a concern that the bent portions 319 will follow the expansion and contraction of the light guide plate 320 and that wrinkles will be generated in the bent portions 319, that is, in the optical sheets 318 when the light guide plate 320, for example, undergoes thermal expansion and contraction. There is a concern that optical characteristics will be degraded in the backlight device 324 if wrinkles are generated in the optical sheets 318. However, since the backlight device 324 of this embodiment is to be used in small-sized terminals, the surface area of the optical sheets 318 is small compared to the case of a backlight device that will be used in a large-sized liquid crystal display device, and it is unlikely that wrinkles will be generated in the optical sheets 318. Consequently, a configuration in which the bent portions 319 are fixed to the light guide plate 320 by the adhesive tape TP can be suitably applied.

### Embodiment 5

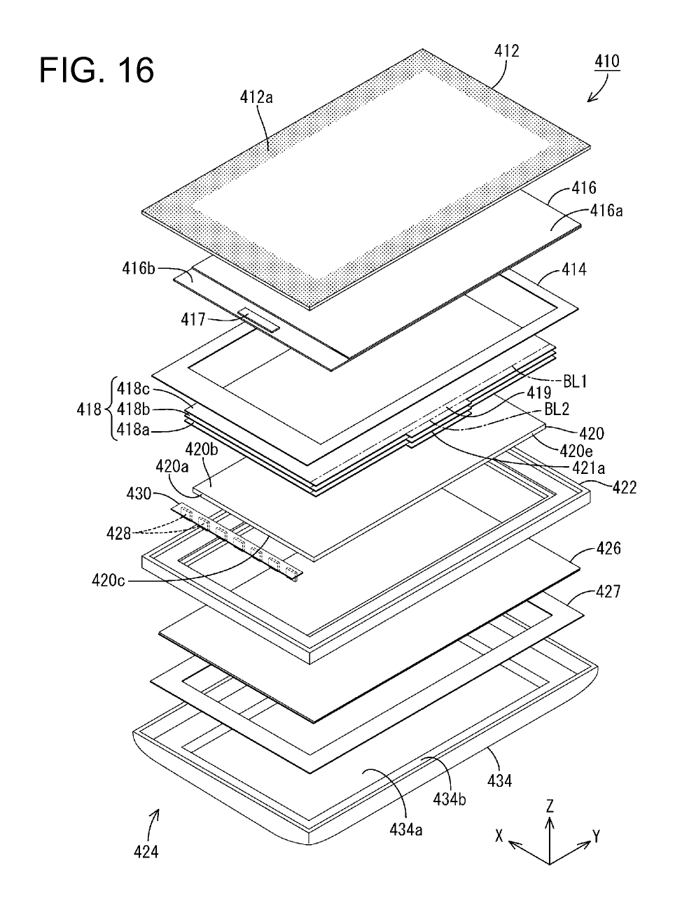

Embodiment 5 will be described while referring to the drawings. Embodiment 5 differs from Embodiment 4 in terms of the configuration of opposite surface covering portions 421a of bent portions 419 of optical sheets 418. The rest of the configuration is the same as that of Embodiment 4, and therefore description of the structure, operation, and effect will be omitted. In addition, in FIG. 16, portions that have had 100 added to the corresponding reference symbols in FIG. 13 are the same as the portions described in Embodiment 4.

In a backlight device 424 according to Embodiment 5, similar to Embodiment 4, a configuration is adopted in which the bent portions 419 have the opposite surface covering portions 421a. In this embodiment, as illustrated in FIG. 16, the opposite surface covering portions 421a each extend from part of the corresponding bent portion 419. By adopting this configuration, the size of the portions (opposite surface covering portions 421a) of the bent portions 419 that are fixed in place by being interposed between a light guide plate 420 and a reflective sheet 426 can be reduced, and therefore the occurrence of wrinkles generated in the vicinity of the portions at the time of, for example, thermal expansion and contraction of the optical sheets 418 due to the portions being fixed in place can be suppressed.

Modification examples of the above-described embodiments are given below.

(1) In the embodiments, a configuration is exemplified in which a bending line is provided at an edge of an optical sheet and a bent portion is bent along the bending line toward an opposite surface side, but a configuration may be instead adopted in which a bending line is not provided at an edge of an optical sheet, for example, and a configuration may be adopted in which an edge of an optical sheet is bent and thus the bent portion is bent toward the opposite surface side.

(2) In the embodiments, a configuration is exemplified in which bent portions are provided at one or two edges among the edges of an optical sheet, but a configuration may be instead adopted in which a bent portion is provided at three or four edges of an optical sheet.

(3) In the embodiments, a configuration is exemplified in which an LED, which is a point light source, is used as a light source, but a configuration may instead be adopted in which a linear light source such as a cold cathode tube is used as a light source.

(4) In Embodiments 1 to 3, a liquid crystal display device of a type equipped with a cabinet is exemplified, but the present invention may instead be applied to a liquid crystal display device not equipped with a cabinet, or namely, a cabinet-less-type liquid crystal display device.

(5) In Embodiments 4 and 5, a configuration is exemplified in which a bent portion (opposite surface covering portion) is fixed to a light guide plate with adhesive tape in a backlight device to be used in a small-sized terminal, but this configuration may also be applied to a large-sized module for example.

(6) In addition to the embodiments, the configuration, arrangement, number, shape, and so forth of the bent portions and opposite surface covering portions can be appropriately changed.

(7) In the embodiments, a liquid crystal display device employing a liquid crystal panel as a display panel is exemplified, but the present invention can also be applied to a display device employing another type of display panel.

(8) In the embodiments, a television receiver equipped with a tuner is exemplified, but the present invention can also be applied to a display device not equipped with a tuner.

Embodiments of the present invention have been described in detail above, but these embodiments are merely illustrative examples and do not limit the scope of the claims. Various modifications and changes to the specific examples exemplified above are included in the technologies described in the claims.

Furthermore, technological elements described in the present specification or drawings exhibit technical utility by themselves or in various combinations and are not limited to the combinations described in the claims at the time of filing of the application. In addition, the technologies exemplified in the present specification or drawings are each capable of simultaneously attaining a plurality of objects and each has technical utility by attaining one of those objects by itself.

### DESCRIPTION OF REFERENCE CHARACTERS

TV television receiver
Ca, Cb cabinet
T tuner
S stand
10, 110, 210, 310, 410 liquid crystal display device
12, 112, 212 bezel
14, 114, 214, 322, 422 frame
16, 116, 216, 316, 416 liquid crystal panel
18, 118, 218, 318, 418 optical sheet
19, 119, 219, 319, 419 bent portion
20, 120, 220, 320, 420 light guide plate
20a, 120a, 220a, 320a, 420a light-receiving side face
20b, 120b, 220b, 320b, 420b light-exiting surface
20c, 120c, 220c, 320c, 420c opposite surface
321, 421a opposite surface covering portion
22, 122, 222 chassis
24, 124, 224, 324, 424 backlight device
26, 126, 226, 326, 426 reflective sheet
28, 128, 228, 328, 428 LED
30, 130, 230, 330, 430 LED substrate
312, 412 cover glass
334, 434 casing
BL1 first bending line
BL2 second bending line
TP adhesive tape

1. An illumination device, comprising:
a light source;
a light guide plate guiding light from the light source and having a light-exiting surface as one plate surface, an opposite surface as another plate surface on a side opposite to the light-exiting surface, and a light-receiving side face as at least one of side faces of the light guide plate, the light guide plate being arranged such that the light-receiving side face faces the light source;
a housing member having at least a plate surface facing the opposite surface of the light guide plate and housing at least the light source and the light guide plate; and
an optical sheet facing the light-exiting surface of the light guide plate and exerting an optical effect on light that has exited therefrom, said optical sheet having a bent portion that extends further outward than an end of the light-exiting surface and that bends toward the opposite surface of the light guide plate, thereby at least partially covering one of said side faces of the light guide plate.

2. The illumination device according to claim 1, wherein the bent portion is arranged over at least the light-receiving side face among said side faces of the light guide plate.

3. The illumination device according to claim 2, wherein the bent portion arranged over the light-receiving side face extends toward the opposite surface of the light guide plate beyond a location that faces a light-emitting surface of the light source.

4. The illumination device according to claim 2, wherein the light source is a point light source.

5. The illumination device according to claim 4, wherein the optical sheet includes two diffusion sheets and a lens sheet interposed therebetween.

6. The illumination device according to claim 4, wherein the point light source is a light-emitting diode package including a plurality of light-emitting diode chips that respectively emit light of differing colors.

7. The illumination device according to claim 6, wherein the optical sheet includes two diffusion sheets.

8. The illumination device according to claim 1, wherein the optical sheet further includes an opposite surface covering portion that extends to the opposite surface of the light guide plate and that covers a part of the opposite surface.

9. The illumination device according to claim 8, wherein the opposite surface covering portion extends from only a part of the optical sheet.

10. The illumination device according to claim 8, wherein the opposite surface covering portion is fixed to the opposite surface of the light guide plate by adhesive tape.

11. The illumination device according to claim 1, wherein the bent portion covers an entirety of at least one of the side faces of the light guide plate.

12. The illumination device according to claim 1,
wherein the light guide plate and the optical sheet each have a rectangular shape when viewed in a plan view, and
wherein the bent portion is respectively provided at one long-side and one short-side of the optical sheet.

13. A display device, comprising:
the illumination device according to claim 1; and
a display panel that performs display using light from the illumination device.

14. The display device according to claim 13, wherein the display panel is a liquid crystal panel using liquid crystal.

15. A television receiver, comprising:
the display device according to claim 13.
